(19) United States
(12) Patent Application Publication
(10) Pub. No.: US 2001/0032053 A1
(43) Pub. Date: Oct. 18, 2001

(54) Imaging of a scattering medium using the equation of radiative transfer

(76) Inventors: Andreas H. Hielscher, Brooklyn, NY (US); Alexander Klose, Brooklyn, NY (US)

Correspondence Address: MORGAN & FINNEGAN, L.L.P., 345 Park Avenue, New York, NY, 10154-0053, US

(21) Appl. No.: 09/767,230

(22) Filed: Jan. 22, 2001

Related U.S. Application Data
(60) Provisional application No. 60/177,779, filed on Jan. 24, 2000.

(51) Int. Cl. G01N 31/00; G06F 19/00

(52) U.S. Cl. 702/22; 702/27; 702/28; 702/30

(57) ABSTRACT

A system and method for improved image reconstruction of the internal properties of a scattering medium is provided. The reconstruction technique employs a model-based iterative image reconstruction scheme. The reconstruction algorithm comprises a forward and inverse model. The forward model of the present method and system is based on the equation of radiative transfer. The forward model predicts the transport of energy through a medium for a given set of internal properties, source positions, source strengths, and boundary conditions, for a medium to be imaged. The inverse model relates the predicted transport of energy to the actual measured energy transport through the medium to determine the actual properties of the medium. The inverse model of the present system and method uses (1) an adjoint differentiation algorithm to determine the gradient of an objective function (normalized error between the predicted and measured values) and (2) minimizes the objective function using a gradient based optimization method. This method and system provides an accurate and efficient scheme for imaging the properties of media having void like regions, high absorbing regions and in general media for which the diffusion approximation is not valid.

This application claims the benefit under 35 U.S.C. §120 of prior U.S. Provisional patent application Ser. Nos. 60/177,779 filed Jan. 24, 2000, entitled IMAGE RECONSTRUCTION IN OPTICAL TOMOGRAPHY.

This invention was made with U.S. Government support under contract number R01 AR46255-01, awarded by the National Institute of Health. The U.S. Government has certain rights in the invention.

### BACKGROUND OF THE INVENTION

1. Field of the Invention

The invention relates to the field of imaging in a scattering medium, and in particular to improved methods of reconstructing images of the spatial distribution of properties inside the scattering medium.

2. Background Information

Imaging of a scattering medium relates generally to an imaging modality for generating an image of the spatial distribution of properties (such as the absorption or scattering coefficients) inside a scattering medium through the detection of energy emerging from the medium.

A typical system for imaging based on scattered energy measures, includes at least one source and detector on the surface of the medium for illuminating the medium and detecting emerging energy, respectively. The source illuminates the target medium with energy that is highly scattered in the medium so that the energy in general does not travel along a straight line path through the medium, but rather, is scattered many times as it propagates through the medium. The detectors on the surface of the medium measure this scattered energy as it exits the target medium. Based on measurements of the scattered energy emerging from the target medium, a reconstructed image representation of the internal properties of the medium can be generated. These systems and methods are in contrast to projection imaging systems, such as x-ray, that measure and image the attenuation or absorption of energy traveling a straight line path between a the x-ray source and a detector.

As will be appreciated, there are many instances where these techniques are highly desirable. For example, one flourishing application is in the field of optical tomography. In recent years optical methods using near-infrared energy (i.e., electromagnetic radiation with wavelengths in the range of ≈700≈1200 nanometers) have become increasingly important for noninvasive diagnostics in medicine. The ability to use near infrared (NIR) energy to probe the human body is of particular interest, because the propagation of NIR energy in tissue is exceptionally responsive to blood oxygenation levels and blood volumes, so that blood acts as a contrast agent. These attributes permit imaging of the vasculature, and thus provide great potential for detecting cardiovascular disease, tumors, brain hemorrhages, breast cancer, rheumatoid arthritis in finger joints, and the like. Furthermore, changes in the scattering properties may also be used as contrast agents. For example, rheumatoid arthritis affects the scattering coefficient of the synovial fluid, which is located inside the joints.

Systems for making measurements on human subjects using sources and detectors as described above are well known and readily available. However, a major challenge remains in the development of algorithms that transform these measurements into useful images on the target medium's internal properties. Since near-infrared energy is strongly scattered in tissue, standard backprojection techniques applied in X-ray tomography have been of limited success. Various other mathematical methods have been developed for solving the reconstruction problem in optical tomography. Some commonly applied schemes are modified backprojection methods, diffraction tomography, perturbation approaches, full matrix inversion techniques and elliptic system methods. Most of these methods employ model-based iterative imaging reconstruction (MOBIIR) techniques. These techniques employ a forward model that provides predictions of the detector readings based on an initial guess of the spatial distribution of properties inside the medium. The predicted detector readings are then compared with experimentally measured readings using an appropriately defined objective function φ. The true distribution of internal properties of the target medium is then determined by iteratively updating the initial guess and performing new forward calculations with these updated internal properties until the predicted data agrees with the measured data from the detector readings. The final distribution of internal properties is then displayed or printed as an image.

These known techniques, however, have several disadvantages. First, all of the known reconstruction schemes are generally based on the diffusion approximation to the equation of radiative transfer. The equation of radiative transport describes the propagation of photons through a scattering medium based in part on the internal properties of the target. The diffusion approximation to this equation, makes several assumptions that reduce the complexity of the equation making it easier and faster to solve. However, the diffusion approximation is only valid for example: (1) for highly scattering media where the properties of the medium μ'ₛ (the scattering coefficient) is much larger than μₐ (the absorption coefficient), (2) for media that do not contain strong discontinuities in optical properties, such as very low scattering and absorbing regions (“void-like regions”) embedded in highly scattering materials, and (3) for large source-detector pair separation, i.e., the separation between a source location and a detector location on the target medium.

If the above conditions are not met, the diffusion approximation will fail to accurately describe energy propagation through the medium. Examples of highly absorbing regions in the body, where the scattering coefficient is not much larger than the absorption coefficient, are hematoma or liver tissue. Void like regions, those having low scattering and low absorbing areas, are present in areas such as the cerebrospinal fluid of the brain, the synovial fluid of human finger joints, or the amniotic fluid in the female uterus. For these cases the diffusion approximation fails and it is highly desirable to have a reconstruction code that is based on the theory of radiative transfer.

Another disadvantage of the known techniques is that most of the currently available reconstruction schemes require the selection of a reference medium having properties nearly identical to the known properties of the target medium, so that there is only a small perturbation between the reference and target medium. Recently, increasing attention has been paid to gradient based iterative image reconstruction (GIIR) methods, which are a subclass of MOBIIR schemes. GIIR schemes overcome the limitations of small perturbations, by using information about the gradient of the objective function (the relative difference between predicted data for the reference and measured data from the target) with respect to the distribution of optical properties in a minimization scheme. However, current techniques for calculating the gradient are impractical due to the complexity of the calculation and the corresponding time required to execute the calculation.

For the foregoing reasons, there is a need for a reconstruction scheme that can efficiently and accurately reconstruct an image of the internal properties of a heterogeneous scattering medium, including but not limited to media that contain void-like regions and media that contain regions in which the absorption coefficient is not much smaller that the scattering coefficient.

### SUMMARY OF THE INVENTION

The present method and system satisfies these needs by providing a gradient-based iterative reconstruction algorithm for imaging of scattering media using (1) the equation of radiative transfer as a forward model, and (2) an adjoint differentiation method for the fast and efficient gradient calculation used in the modification of the initial guess in the updating scheme.

One embodiment of the present method and system provides a method for making an initial guess of the internal properties of a target medium, predicting the propagation of energy through the medium based on the initial guess, measuring the actual propagation of energy through the medium, updating the initial guess based on the predicted data and measured data. The predicted propagation of energy is calculated using the equation of radiative transfer and an initial guess as to what the spatial properties of the target might be. The measured propagation is obtained by directing energy into the target and measuring the energy emerging from the target. An objective function is then generated that relates the predicted values to the measured values. The objective function gives an indication of how far the initial guess of the spatial properties of the target was from the actual spatial properties of the target. A gradient of the objective function is then generated using a method of adjoint differentiation. The gradient indicates how that initial guess should be adjusted to make the predicted data more closely match the measured data. This process is then repeated until the predicted and measured data are within an acceptable error. At this point the adjusted initial guess is representative of the spatial properties of the actual target and an image is generated therefrom.

The foregoing specific objects and advantages of the invention are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWING

For a better understanding of the invention, together with the various features and advantages thereof, reference should be made to the following detailed description of the preferred embodiments and to the accompanying drawings wherein:

FIG. 1 is a flow chart of the reconstruction process;

FIG. 2 is a schematic of an exemplary measurement and imaging system;

FIG. 3A is a computational graph of the forward model calculating the objective function; and

FIG. 3B is a computational graph of the adjoint differentiation technique.

### DETAILED DESCRIPTION OF THE INVENTION

I. Introduction

As discussed above, imaging of a scattering medium refers generally to the methods and techniques of reconstructing an image of the internal properties of a scattering medium based on the transmission of energy into the medium and the measurement of the scattered energy emerging from the medium.

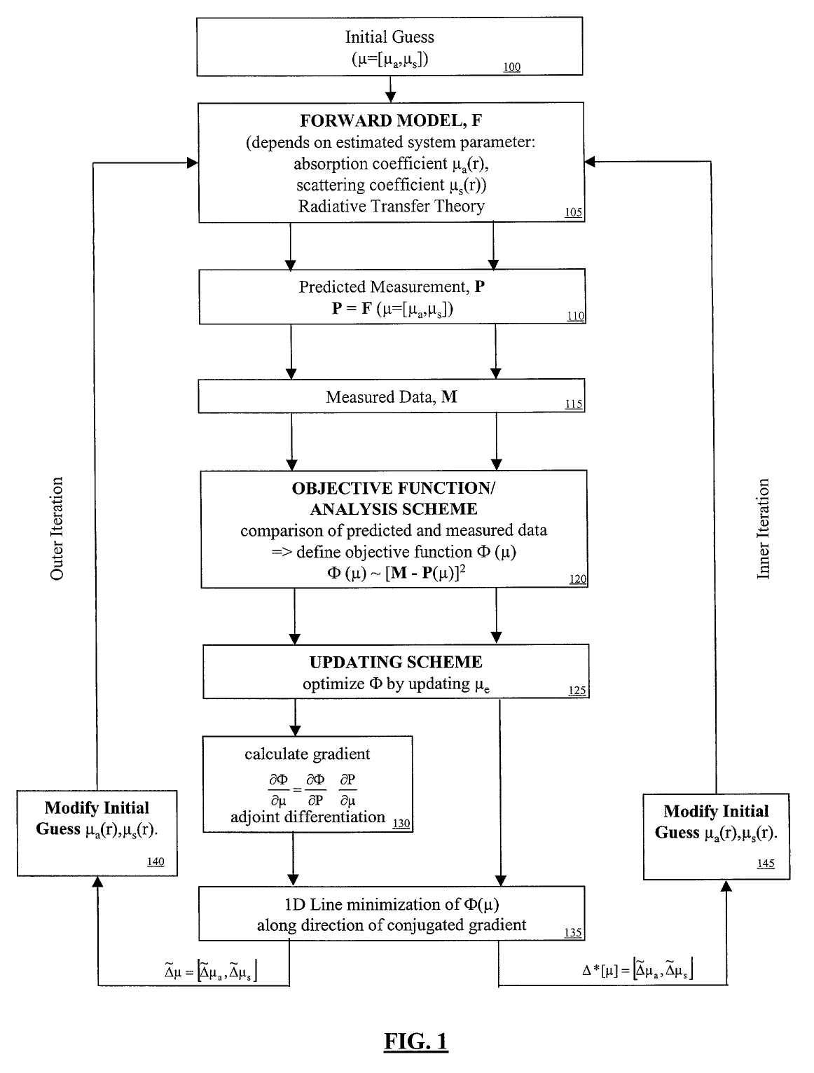

The present method and system employs an iterative image reconstruction scheme that has three major elements. The following sections describe in detail how the three major elements of the present method and system work together to yield a reconstructed image of the internal properties of the scattering target medium. First, the solution of the forward model of the equation of radiative transfer is solved using an upwind difference scheme, even-parity finite-element formulation or the like; by way of example, the present invention is illustrated using the upwind scheme. This is followed with a detailed description of the second and third component, namely the objective function and the updating scheme, in which adjoint differentiation is used for the gradient calculation. Referring to FIG. 1, these elements are illustrated as the forward model 105, the objective function/analysis scheme 120 and the updating scheme 125.

The forward model starts at step 100 with an initial guess μ₀=[μ_{s.0}(r), μ_{a.0}(r)] (scattering and absorption coefficients respectively) of the internal properties, known energy source S(rₛ) at the positions rₛ and given boundary conditions. Based on the initial guess go, energy source S(rₛ) and the given boundary conditions the forward model (1) gives a numerical solution of the energy distribution Ψ(r) inside the target scattering medium, and (2) predicts the energy radiance Ψ_{d} on the boundary Ω of the medium based on the equation of radiative transfer. Referring to step 110 of FIG. 1, the vector P, generated by the forward model, contains the predicted radiance value Ψ_{d}, or derived parameter related thereto, at each detector, for each source detector pair, as a function of the properties μ. Measured data for the actual target to be imaged is then collected in step 115. The measured radiance at each detector, for each source detector pair is stored in the vector M. A typical imaging system for collecting the measured data is presented in detail below.

In the analysis scheme, step 120, the predicted radiances Ψ_{d}(μ₀) are compared with the set of measured radiances M on the boundary Ω of an actual target medium to define an objective function Φ. In steps 125 through 135, an optimization technique is used to minimize the objective function Φ, e.g., the normalized difference between the predicted and measured values. For this optimization the internal properties μ₀ are updated using the derivative dΦ/dμ of the objective function with respect to the internal properties. In step 130, the gradient is computed by an adjoint differentiation technique, that takes advantage of a well-chosen numerical discretization of the forward model.

Once the gradient is computed, the initial guess is modified in step 140 or 145, depending on whether an inner or outer iteration is being performed, and a new forward calculation is performed based on the new set of internal properties μ₀=Δμ. The iteration process continues until the minimum of the objective function is reached within a specified error. At this point the predicted detector readings are identical to the measured detector readings within a given tolerance. The internal properties, μ, of the target medium are then mapped into an image.

For illustration purposes, the present system and method is described in further detail below with respect to an optical tomography system. However, it will be appreciated by those skilled in the art that the methodology of the present invention is applicable for any energy source (e.g., electromagnetic, acoustic, etc.), any scattering medium (e.g., body tissues, oceans, foggy atmospheres, geological strata, and various materials, etc.), and any source condition (e.g., time-independent, time-harmonic, time-resolved). Its applicability is dependent only on the presence of the phenomenology described herein, (i.e., radiative transfer being the principal mechanism of energy transport), which is expected in all cases where scattering occurs. Accordingly, this methodology can be extended to allow for new imaging approaches in a broad range of applications, including nondestructive testing, geophysical imaging, medical imaging, and surveillance technologies.

II. Exemplary Measuring System

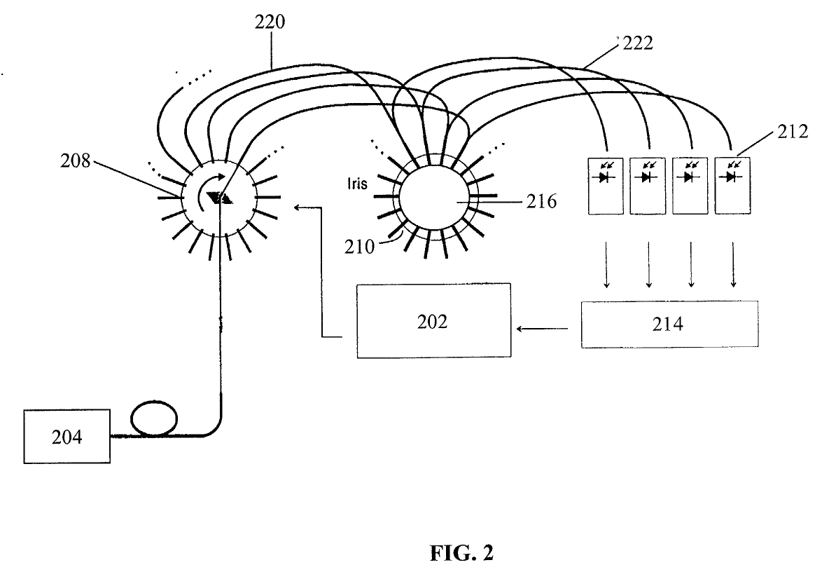

There are many known imaging systems for collecting the measured data used in image reconstruction. A schematic illustration of an exemplary optical tomography system is shown in FIG. 2. This system includes a computer 202, energy source 204, a fiber switcher 208, an imaging head 210, detectors 212, a data acquisition board 214, source fibers 220 and detector fibers 222.

The energy source 204 provides optical energy, directed through the fiber switcher 208 to each of the plurality of source fibers 120 one at a time in series. The source fibers 220 are arranged around an imaging head 210 so that the energy is directed into the target medium 216 at a plurality of source locations around the target.

The energy leaves the source fiber 220 at the imaging head 210 and enters the target medium 216 centered in the imaging head 210. The energy is scattered as it propagates through the target medium, emerging from the target medium at a plurality of locations. The emerging energy is collected by the detector fibers 222 arranged around the imaging head 210. The detected energy then travels through the detector fibers 222 to detectors 212 having energy measuring devices that generate a signal corresponding to the measurement. The data acquisition board 214 receives the measurement signal for delivery to the computer 202.

This process is repeated for each source position so that a vector of measures are obtained for all of the detectors and source locations. This vector of measured data is the vector M referred to above. The vector of data M is stored by the computer 202 for use in image reconstruction and other analysis discussed below.

III. Forward Model

As discussed in the introduction above, the present method and system compares measured data M from the actual target with predicted data P for the target. The predicted data is obtained through the “forward” model.

In the present method and system, the equation of radiative transfer is used for the forward model. Referring to FIG. 1, steps 100 through 110, the radiative transfer equation is used to predict the detector readings of energy emerging at one or more detector locations on the scattering medium based on an initial guess of the properties of the medium. The equation of radiative transfer is derived by considering energy conservation in a small volume. The equation for time-dependent case can be written as:

$$\frac{1}{c} \partial Ψ \frac{( r , ω , t )}{\partial t} = S ( r , ω , t ) - ω \cdot ∇ Ψ ( r , ω , t ) - ( {μ}_{a} + {μ}_{s} ) Ψ ( r , ω , t ) + {μ}_{s} {\int }_{0}^{2 π} p ( ω , {ω}^{′} ) Ψ ( r , {ω}^{′} , t ) ⅆ {ω}^{′} . \qquad ( 1 a )$$

and; for the time-independent case can be written as:

ωΔΨ(r,ω)+(μ_{α}+μₛ)Ψ(r,ω)=S(r,ω)+μₛ∫₀^{2π}ρ(ω,ω′)Ψ(r,ω′)dω′, (1b)

where r is the spatial position vector, co is a unit vector pointing in the direction of photon propagation, Ψ(r,ω,t) and Ψ(r,ω) are the energy radiance in units of W cm⁻² sr⁻¹. S(r,ω,t) and S(r,ω) are the source terms representing energy directed into a solid angle centered on ω in a unit volume at r, μₛ is the scattering coefficient given in units of cm⁻¹, μₐ is the absorption coefficient given in units of cm⁻¹ and ρ(ω,ω′) is the phase function that describes the probability that a photon with direction ω′ will be scattered into the direction ω during a scattering event.

The scattering phase function ρ(ω, ω′) can be described, for example, using the well known Henyey-Greenstein scattering function,

$$p ( cos θ ) = \frac{1 - {g}^{2}}{2 {( 1 + {g}^{2} - 2 g cos θ )}^{3 / 2}} . \qquad ( 2 )$$

where θ is the angle between the two directions ω and ω′. The parameter g is the anisotropy factor which is commonly used to characterizes the angular distribution of scattering. It can range from g=−1 (total backward scattering), over g=0 (isotropic scattering), to g=1 (strictly forward scattering). Biological tissues typically have a g-factor between g=0.7 and g=0.98. Other scattering phase functions are also possible, for example derived from Mie theory.

The integral of the radiance over all angles ω at one point r yields the fluence rate Φ(r) for the time-independent case:

$$Φ ( r ) = {\int }_{2 π} Ψ ( r , ω ) ⅆ ω \qquad ( 3 )$$

While it will be appreciated to those skilled in the art that a similar three-dimensional and/or time dependent equation can be generated, by way of example the remainder of the specification will focus on the two-dimensional, time-independent problem.

Various computational techniques exist, such as those disclosed by Lewis E E, Miller W F, Computational Methods of neutron transport, New York, John Wiley & Sons, 1984, that numerically solve the equation of radiative transfer. Techniques commonly applied include the singular eigenfunction method, the method of spherical harmonics, the method of characteristics, the finite-element method, and the finite-difference discrete-ordinate method. A concise review of these techniques has been presented by Sanchez R, McCormick N J, A Review of neutron transport approximations. Nucl. Sci. Eng. 1982,80:481-535; and McCormick N J, Inverse radiative transfer problems: a review, Nucl. Sci. Eng. 1992,112:185-198. The discrete-ordinates method is widely used with several different finite-difference approximations, such as the diamond-difference scheme, the weighted diamond-difference scheme, or the centered-difference scheme.

Another means of solving the equation of radiative transfer is the upwind-difference scheme used in connection with the discrete-ordinates method to the equation of radiative transfer disclosed by Sewell G., The numerical solution of ordinary and partial differential equations, San Diego, Academic Press, 1988. This method is a computationally efficient method for the calculation of the radiance and has the advantage that it easily supplies the required mathematical structure for the adjoint differentiation calculation. The adjoint differentiation method is crucial for obtaining the gradient of the objective function in an computationally efficient way, and thus obtaining an update of the initial guess of the properties of the target medium. The adjoint differentiation method and the objective function will be described in detail below in Section IV.

Returning to the forward problem, to solve the equation of radiative transfer with an upwind-difference discrete-ordinates method, the angular and spatial variables have to be discretized. First, the integral term in equation 1b is replaced by a quadrature formula that uses a finite set of K angular directions ωₖ with k=1, . . . K. This yields a set of K coupled ordinary differential equations for the angular-dependent radiance Ψₖ(r)=Ψ(r,ωₖ) in the directions ωₖ. The coupling term is the internal source term

$${μ}_{s} {\sum }_{{k}^{′} = 1}^{K} {a}_{{k}^{′}} p ( {ω}_{{k}^{′}} , {ω}_{k} ) Ψ ( r , {ω}^{′} ) .$$

The parameter α_{k′} is a weighting factor that depends on the chosen quadrature formula. In this work the extended trapezoidal rule is employed.

$${ω}_{k} ∇ {Ψ}_{k} ( r ) + ( {μ}_{a} + {μ}_{s} ) {Ψ}_{k} ( r ) = {S}_{k} ( r ) + {μ}_{s} {\sum }_{{k}^{′} = 1}^{k} {a}_{{k}^{′}} {p}_{{kk}^{′}} {Ψ}_{{k}^{′}} ( r ) \qquad ( 4 )$$

Additionally, the spatial variable r needs to be discretized. The domain Ω is defined by a rectangular spatial mesh with M grid points on the x-coordinate and N grid points on the y-coordinate. The distance between two adjacent grid points along the x-axis is Δx and along the y-axis is Δy. The angular radiance at the grid point (i,j) with position r=(xᵢ, yⱼ) for a particular direction ωₖ is represented by Ψ_{k,i,j}=Ψₖ(xᵢ, yⱼ). The angular direction ωₖ can be expressed in cartesian coordinates with ξₖ=eₓ.ωₖ=cos (ωₖ) and ηₖ=e_{y}.ωₖ=sin (ωₖ). The transport equation can now be written as:

$${ξ}_{k} \frac{\partial {Ψ}_{k} ( {x}_{i} , {y}_{j} )}{\partial x} + {n}_{k} \frac{\partial {Ψ}_{k} ( {x}_{i} , {y}_{j} )}{\partial y} + ( {μ}_{a} + {μ}_{s} ) {Ψ}_{k} ( {x}_{i} , {y}_{j} ) = {S}_{k} ( {x}_{i} , {y}_{j} ) + {μ}_{s} {\sum }_{{K}^{′} = 1}^{K} {}_{}^{a}{K}{}_{}^{′} {p}_{{kk}^{′}} {Ψ}_{{k}^{′}} ( {x}_{i} , {y}_{j} ) \qquad ( 5 )$$

Finally, the spatial derivatives have to be replaced with a finite-difference scheme. The upwind-difference formula depends on the direction ωₖ of the angular-dependent radiance Ψₖ. Thus, the set of all angular directions ωₖ are subdivided into four quadrants to generate four different difference formulas for the radiance Ψ_{k,i,j}, depending on the sign of ξₖ and ηₖ:

$$\begin{matrix}I ) {ξ}_{k} > 0 , {η}_{k} > 0 : \frac{\partial Ψ}{\partial x} \approx {δ}_{x} {Ψ}_{k , i , j} = \frac{{Ψ}_{i , j} - {Ψ}_{t - 1 , j}}{Δ x} , \frac{\partial Ψ}{\partial y} \approx {δ}_{y} {Ψ}_{k , i , j} = \frac{{Ψ}_{i , j} - {Ψ}_{i , j - 1}}{Δ y} & ( 6 a ) \\ II ) {ξ}_{k} < 0 , {η}_{k} > 0 : \frac{\partial Ψ}{\partial x} \approx {δ}_{x} {Ψ}_{k , i , j} = \frac{{Ψ}_{i + 1 , j} - {Ψ}_{i , j}}{Δ x} , \frac{\partial Ψ}{\partial y} \approx {δ}_{y} {Ψ}_{k , i , j} = \frac{{Ψ}_{i , j} - {Ψ}_{i , j - 1}}{Δ y} & ( 6 b ) \\ III ) {ξ}_{k} > 0 , {η}_{k} < 0 : \frac{\partial Ψ}{\partial x} \approx {δ}_{x} {Ψ}_{k , i , j} = \frac{{Ψ}_{ij} - {Ψ}_{i - 1 , j}}{Δ x} , \frac{\partial Ψ}{\partial y} \approx {δ}_{y} {Ψ}_{k , i , j} = \frac{{Ψ}_{i , j + 1} - {Ψ}_{i , j}}{Δ y} & ( 6 c ) \\ IV ) {ξ}_{k} < 0 , {η}_{k} < 0 : \frac{\partial Ψ}{\partial x} \approx {δ}_{x} {Ψ}_{k , i , j} = \frac{{Ψ}_{i + 1 , j} - {Ψ}_{i , j}}{Δ x} , \frac{\partial Ψ}{\partial y} \approx {δ}_{y} {Ψ}_{k , i , j} = \frac{{Ψ}_{i , j + 1} - {Ψ}_{i , j}}{Δ y} & ( 6 d )\end{matrix}$$

The time-independent radiative transfer equation, with the external and internal source terms on the right-hand-side, can now be written as:

$${ξ}_{k} \cdot {δ}_{x} {Ψ}_{k , i , j} + {η}_{k} \cdot {δ}_{y} {Ψ}_{k , i , j} + ( {μ}_{a} + {μ}_{s} ) {Ψ}_{k , i , j} = {S}_{k , i , j} + {μ}_{s} {\sum }_{{k}^{′} = 1}^{K} {a}_{{k}^{′}} {p}_{k , {k}^{′}} {Ψ}_{{k}^{′} , i , j} \qquad ( 7 )$$

Recasting the left-hand side of the preceding equation as a single operator acting upon Ψ_{k,i,j}, produces;

$$\{ {ξ}_{k} \cdot {δ}_{x} + {η}_{k} \cdot {δ}_{y} + ( {μ}_{a} + {μ}_{s} ) \} {Ψ}_{k , i , j} = {S}_{k , i , j} + {μ}_{s} {\sum }_{{k}^{′} = 1}^{K} {a}_{{k}^{′}} {p}_{k , {k}^{′}} {Ψ}_{{k}^{′} , i , j} , \qquad ( 8 )$$

from which it is apparent that the system of equations 8 corresponding to all K directions can be written as a single matrix equation:

AΨ=b; (9)

proportional to one row of the matrix A and with an ordering of the radiance vector for a fixed k with, for example ξₖ>0,ηₖ>0, Ψ=(Ψ_{k,1,1}, Ψ_{k,1,2}, . . . , Ψ_{k,2,1}, Ψ_{k,2,2}, . . . , Ψ_{k,i,j}, . . . Ψ_{k,M,N}) produces:

$${ξ}_{k} {Ψ}_{k , i , j} - \frac{{Ψ}_{k , i - 1 , j}}{Δ x} + {η}_{k} {Ψ}_{k , i , j} - \frac{{Ψ}_{k , i , j - 1}}{Δ y} + ( {μ}_{a} + {μ}_{s} ) {Ψ}_{k , i , j} = {S}_{k , i , j} + {μ}_{s} {\sum }_{{k}^{′} = 1}^{K} {a}_{{k}^{′}} {p}_{k , {k}^{′}} {Ψ}_{{k}^{′} , i , j} \qquad ( 10 )$$

The resulting system of equations for the radiance Ψ_{k,i,i} for all grid points is solved for each ordinate index k by a Gauss-Seidel method. Accordingly, the matrix A is split into a diagonal part D, an upper-triangular part U, and a lower-triangular part L, with A=L+D+U. The original matrix equation 9 is now be written as either:

(L+D+U)Ψ=b (11a)

or,

(D+L)Ψ=−UΨ+b (11b)

In this case an upper matrix U does not exist. Thus, for example for the case ξₖ>0, ηₖ>0:

$$\{ \frac{ξ}{Δ x} + \frac{{n}_{k}}{Δ y} + ( {μ}_{a} + {μ}_{s} ) \} {Ψ}_{k , i , j} - \frac{ξ}{Δ x} {Ψ}_{k , i , j - 1} \frac{{η}_{k}}{Δ y} {Ψ}_{k , i , j - 1} = {S}_{k , i , j} + {μ}_{s} {\sum }_{{k}^{′} = 1}^{K} {a}_{{k}^{′}} {p}_{k , {k}^{′}} {Ψ}_{{k}^{′} , i , j} \qquad ( 12 )$$

diagonal matrix D lower matrix L b

Now the iterative form with the iteration matrix (D+L) is expressed as

(D+L)Ψ^{z+1}=−UΨ^{z}+b, (13)

and for the case ξₖ>0, ηₖ>0:

$$\begin{matrix}\frac{ξ}{Δ x} + \frac{{n}_{k}}{Δ y} + ( {μ}_{a} + {μ}_{s} ) \} {Ψ}_{k , i , j}^{z + 1} = \frac{{ξ}_{k}}{Δ x} {Ψ}_{k , i , j - 1}^{z + 1} - \frac{{η}_{k}}{Δ y} {Ψ}_{k , i , j - 1}^{z\_ 1} = {S}_{k , i , j} + {μ}_{s} {\sum }_{{k}^{′} = 1}^{K} {a}_{{k}^{′}} {p}_{k , k} {Ψ}_{{k}^{′} , i , j}^{z} , \\ & ( 14 ) \\ {Ψ}_{k , i , j}^{z + 1} = \frac{\{ {S}_{k , i , j} + {μ}_{s} {\sum }_{{k}^{′} = 1}^{K} {a}_{{k}^{′}} {p}_{k , {k}^{′}} {Ψ}_{{k}^{′} , i , j}^{z} + \frac{{ξ}_{k}}{Δ x} {Ψ}_{k , i - 1 , j}^{z + 1} + \frac{{η}_{k}}{Δ y} {Ψ}_{k , i , j - 1}^{z + 1} \}}{\{ \frac{ξ}{Δ x} + \frac{{n}_{k}}{Δ y} + ( {μ}_{a} + {μ}_{s} ) \}} . & ( 15 )\end{matrix}$$

All Ψ_{k,i-l,j}^{z+1} and Ψ_{k,l,j-1}^{z+1} are already calculated at the current iteration step because of the vector ordering. For all other ordinates ωₖ besides ξₖ>0, ηₖ>0, the radiance vector Ψ has to be re-ordered to get the same matrix structure with (D+L)Ψ=−UΨ+b. The iteration process is repeated until the error norm E=∥Ψ_{k,l,j}^{z+1}−Ψ_{k,l,j}^{z}∥ at the grid point (ij) is smaller than a defined α.

A significant improvement in convergence speed can be achieved by a slight modification to the Gauss-Seidel method. The successive over-re laxation (SOR) method uses a relaxation parametero ρ with 1<ρ<2 in order to correct the solution Ψ_{k,i,j}^{z+1} of the Gauss-Seidel iteration, now denoted \overline{Ψ}_{k,l,j}^{z+1}. The updated value Ψ_{k,l,j}^{z+1} of the SOR is a linear combination of the Gauss-Seidel value \overline{Ψ}_{k,l,j}^{z+1} and the previously computed value Ψ_{k,l,j}^{z} of the SOR using:

$${Ψ}_{k , i , j}^{z + 1} = ( 1 - ρ ) {Ψ}_{k , i , j}^{z} + ρ {\overline{Ψ}}_{k , i , j}^{z + 1} . \qquad ( 16 )$$

The boundary conditions are treated between each successive iteration steps. Because of the refraction index mismatch at the air-tissue interface, the outgoing radiance is partly reflected on the boundary and only a fraction of that energy escapes the medium. The internally reflected energy contributes further to the photon propagation inside the medium, while the transmitted energy enters the detectors. Using Fresnel's formula, the transmissivity T and reflectivity R are calculated at the boundary grid points for each ordinate ωₖ and for the given refractive indices. The reflectivity R and the transmissivity T are defined as

$$R = \frac{{sin}^{2} ( {ω}_{trans} - {ω}_{in} ) + {sin}^{2} ( {ω}_{trans} + {ω}_{in} )}{2} . \qquad ( 17 )$$

T−1−r (18)

The angles ωₜᵣₐₙₛ, which pertain to radiances escaping the object, are determined by Snell's law (n_{object} sin ωᵢₙ=nₐᵢᵣ sin ωₜᵣₐₙₛ) given the angleωᵢₙ of the radiance, which hits the boundary inside the object. The angle ω_{ref}=−ωᵢₙ is just the angle of the reflected radiance on the boundary inside the object. The transmitted and the reflected radiance are calculated with:

Ψₜᵣₐₙₛ^{z}=T.Ψᵢₙ^{z}, (19)

Ψ_{ref}^{z}=R.Ψᵢₙ^{z}. (20)

The fluence Φᵢⱼ, on the boundary at the grid point (i,j), which enters the detector, is calculated for a given detector aperture AP using the transmitted radiance,

$$Φ ( {x}_{1} , {y}_{i} ) = {\int }_{AP} Ψ ( {x}_{i} . {y}_{i} , ω ) ⅆ ω \approx {\sum }_{k = {k}_{1}}^{k = {k}_{2}} {a}_{k} {Ψ}_{k , i , j} = {Φ}_{i , j} . \qquad ( 21$$

The weighting factors αₖ are given by the extended trapezoidal rule, [84] which provides the quadrature formula in this work.

These fluence values Φᵢⱼ on the boundary provide the vector of predicted values shown in step 110 of FIG. 1 used for the reconstruction algorithm.

IV. Objective Function/Analysis Scheme and Updating Scheme

The first components of the present method and system, i.e., the forward model used to generate the predicted energy emerging from the target, and the collection of measured energy emerging from the target, have been described in detail above. The following sections describe the second and third components of the method and system, illustrated in steps 120 through 135 of FIG. 1, namely, the objective function and the updating scheme, in which adjoint differentiation is used for the gradient calculation. These second and third components are used to modify the initial guess of the internal properties of the medium in an iterative process.

1. Objective Function/Analysis Scheme

Optical tomography can be viewed as an optimization problem with a non-linear objective function. Referring to FIG. 1, step 120, the discrepancy between the actual measurements, represented by the vector M, and the predictions, given by the vector P, for m source-detector pairs is defined by a scalar-valued objective function Φ(P). The predictions P are mapped onto a scalar φ using the χ²—error norm:

Φ:R^{m}→R (22a)

$$P ↦ ϕ = \frac{1}{2} {\sum }_{i}^{m} {( {P}_{i} - {M}_{i} )}^{2} \qquad ( 22 b )$$

The predictions P are determined for all m source-detector positions by evaluating the forward model F, given the spatial distribution of internal properties μ (see Part I):

F:Rⁿ→R^{m} (23a)

μ├→P(μ) (23b)

The vector μ is of length n=2 I J, and contains the internal properties μₛ and μₐ. The parameters I and J denote the number of grid points of a finite-difference grid along the x-axis and y-axis, respectively.

The goal in image reconstruction is to determine a vector μ that minimizes the objective function Φ. As already mentioned in the introduction, gradient-based optimization techniques, such as the conjugate-gradient method, employ the gradient Δ_{μ}Φ(μ) to calculate a sequence of points μ₀, μ₁, . . . , μᵢ that lead to ever-improving values of Φ. This iterative process is terminated when |Φ(μᵢ₊₁)−Φ(μᵢ)| becomes smaller than a predefined value ε. A crucial task within this process is the computationally efficient calculation of the gradient Δ_{μ}Φ(μᵢ). The following section describes in detail how this can be done using an adjoint differentiation scheme.

2. Gradient Calculation With Adjoint Differentiation

In adjoint differentiation schemes the numerical code that calculates the objective function Φ is directly differentiated to obtain the gradient Δ_{μ}Φ(μᵢ), FIG. 1, step 130. To apply this method one has to decompose the objective function into a series of elementary differentiable function steps. By systematically applying the chain rule of differentiation to each of these elementary steps in the reverse direction of the forward model computation, a value for the gradient is obtained.

The parameter Φ=Φ(P(μ)) can be decomposed into sub-functions F^{e} in the following way:

Φ(F(μ))=Φ(F^{Z}(F^{Z-1}(F^{Z-2}(. . . (F²(F¹(μ),μ)). . )μ)μ):=(Φ∘F^{Z}(μ)∘F^{Z-1}(μ)∘F^{Z-2}(μ)∘. . . ∘F²(μ)∘F¹)(μ). (24)

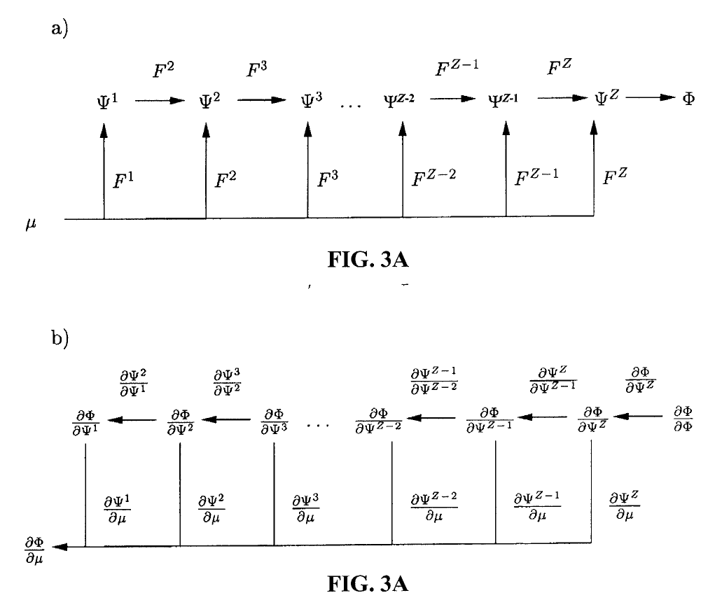

The sub-functions F^{e} are defined by the SOR-method that is used to solve the forward model (see Part I). The SOR-method is an iterative approach and the z-th iteration yields the intermediate result Ψ_{k,i,j}^{z}. The radiance vector Ψ of length ρ=KxIxJ with kε[1,K], i ε[1,I], and j ε[1,J]. The detector readings P(μ) are the angular-dependent radiances Ψ_{k,i,j}^{z} at the last iteration step Z at detector positions (i,j) on the boundary. The computational graph of the forward model is depicted in FIG. 3A. Starting with the internal properties μ as the input variables, the sub-function F¹ produces the intermediate result and output variable Ψ^{k}. The output variables Ψ^{z} of F^{e} and the internal properties μ always serve as input variables for the next sub-function F^{e+1} for all subsequent steps of the decomposition. The step F^{Z} calculates the predictions P, which become the input to the final step of the objective function Φ determination, which is the calculation of the scalar φ.

The sub-functions F^{e} map the intermediate variables Ψ^{z-1} and constant input values of μ onto the intermediate result Ψ^{Z}=F^{Z}(Ψ^{Z-1}, μ) for all iteration steps of the transport forward model:

$$\begin{matrix}{F}^{z} : {ℜ}^{p} \times {ℜ}^{n} \to {ℜ}^{p} & ( 25 a ) \\ ( \begin{matrix}{Ψ}^{z - 1} \\ μ\end{matrix} ) ↦ {Ψ}^{z} , & ( 25 b )\end{matrix}$$

For the ordinates with ξₖ>0, ηₖ>0 this mapping is given explicitly by:

$${Ψ}_{k , i , j}^{z + 1} = ( 1 - ω ) {Ψ}_{k , i , j}^{z - 1} + ω \frac{\{ {S}_{k , i , j} + {μ}_{s} {\sum }_{{k}^{′} = 1}^{K} {a}_{{k}^{′}} {p}_{k , {k}^{′}} {Ψ}_{{k}^{′} , i , j}^{z - 1} + \frac{{ξ}_{k}}{Δ x} {Ψ}_{k , i - 1 , j}^{z} + \frac{{η}_{k}}{Δ y} {Ψ}_{k , i , j - 1}^{z} \}}{\{ \frac{{ξ}_{k}}{Δ x} + \frac{{n}_{k}}{Δ y} + ( {μ}_{a} + {μ}_{s} ) \}} \qquad ( 26 )$$

For the first iteration step z=1, F^{Z} only maps the input variables μ:

F¹:Rⁿ→R^{ρ} (27a)

μ├→Ψ¹ (27b)

and produces:

$${Ψ}_{k , i , j}^{1} = ω \frac{\{ {S}_{k , i , j} + \frac{{ξ}_{k}}{Δ x} {Ψ}_{k , i - 1 , j}^{1} + \frac{{η}_{k}}{Δ y} {Ψ}_{k , i , j - 1}^{1} \}}{\{ \frac{{ξ}_{k}}{Δ x} + \frac{{n}_{k}}{Δ y} + ( {μ}_{a} + {μ}_{s} ) \}} . \qquad ( 28 )$$

Equations 26 and 28 are the smallest computational units in the forward code and play an important role in the adjoint differentiation step, which is discussed below. The gradient Δ_{μ}Φ of the objective function is obtained by differentiating equation 24 with respect to the internal properties μ. The total derivative Δ_{μ}Φ can be obtained by systematically applying the chain rule of differentiation to equation 22. The total derivative Δ_{μ}Φ is a composition of derivatives of all intermediate steps of the forward model due to the explicit dependence of the intermediate results on the internal properties. Starting from the last step of the forward code, in which the objective function Φ is calculated given the predicted detector readings P=Ψ^{Z}, the total derivative is given by the chain rule as:

$${( \frac{ⅆ Φ}{ⅆ μ} )}^{T} = {( \frac{\partial Φ}{\partial {Ψ}^{z}} )}^{T} \frac{ⅆ {Ψ}^{z}}{ⅆ μ} + {( \frac{\partial Φ}{\partial μ} )}^{T} . \qquad ( 29 )$$

The derivative

$$\frac{ⅆ {Ψ}^{z}}{ⅆ μ}$$

is obtained by again applying the chain rule of differentiation:

$$\frac{ⅆ {Ψ}^{z}}{ⅆ μ} = \frac{\partial {Ψ}^{z}}{\partial {Ψ}^{z - 1}} \frac{ⅆ {Ψ}^{z - 1}}{ⅆ μ} + \frac{\partial {Ψ}^{z}}{\partial μ} . \qquad ( 30 )$$

Equations 29 and 30 yield together:

$${( \frac{ⅆ Φ}{ⅆ μ} )}^{T} = {( \frac{\partial Φ}{\partial {Ψ}^{z}} )}^{T} \frac{\partial {Ψ}^{z}}{\partial {Ψ}^{z - 1}} \frac{ⅆ {Ψ}^{z - 1}}{ⅆ μ} + {( \frac{\partial Φ}{\partial {Ψ}^{z}} )}^{T} \frac{\partial {Ψ}^{z}}{\partial μ} + {( \frac{\partial Φ}{\partial μ} )}^{T} . \qquad ( 31 )$$

In the next step the total derivative

$$\frac{ⅆ {Ψ}^{z - 1}}{ⅆ μ}$$

is replaced again. This process is repeated for all total derivatives down to the first step

$$\frac{ⅆ {Ψ}^{1}}{ⅆ μ} = \frac{\partial {Ψ}^{1}}{\partial μ} ,$$

, to obtain:

$${( \frac{ⅆ Φ}{ⅆ μ} )}^{T} = \{ {( \frac{\partial Φ}{\partial {Ψ}^{z}} )}^{T} \frac{\partial {Ψ}^{z}}{\partial {Ψ}^{z - 1}} ⃛ \frac{\partial {Ψ}^{2}}{\partial {Ψ}^{1}} \frac{\partial {Ψ}^{1}}{\partial μ} \} + \{ {( \frac{\partial Φ}{\partial {Ψ}^{z}} )}^{T} \frac{\partial {Ψ}^{z}}{\partial {Ψ}^{z - 1}} ⃛ \frac{\partial {Ψ}^{3}}{\partial {Ψ}^{2}} \frac{\partial {Ψ}^{2}}{\partial μ} \} + ⃛ + \{ {( \frac{\partial Φ}{\partial {Ψ}^{z}} )}^{T} \frac{\partial {Ψ}^{z}}{\partial μ} \} + {( \frac{\partial Φ}{\partial μ} )}^{T} \qquad ( 32 )$$

or, using the short hand notation

$$\{ {( \frac{\partial Φ}{\partial {Ψ}^{z}} )}^{T} \frac{\partial {Ψ}^{z}}{\partial {Ψ}^{z - 1}} ⃛ \frac{\partial {Ψ}^{z + 1}}{\partial {Ψ}^{z}} \} = \frac{\partial {( {Φ•Ψ}^{z} • ⃛ {•Ψ}^{z + 1} )}^{T}}{\partial {Ψ}^{z}} = {( \frac{\partial Φ}{\partial {Ψ}^{z}} )}^{T} \qquad ( 33 )$$

rewriting equation 33 produces:

$$\begin{matrix}{( \frac{ⅆ Φ}{ⅆ μ} )}^{T} = {( \frac{\partial Φ}{\partial {Ψ}^{1}} )}^{T} \frac{\partial {Ψ}^{1}}{\partial μ} + {( \frac{\partial Φ}{\partial {Ψ}^{2}} )}^{T} \frac{\partial {Ψ}^{2}}{\partial μ} + ⃛ + {( \frac{\partial Φ}{\partial {Ψ}^{z}} )}^{T} \frac{\partial {Ψ}^{z}}{\partial μ} + ⃛ + {( \frac{\partial Φ}{\partial {Ψ}^{z}} )}^{T} \frac{\partial {Ψ}^{z}}{\partial μ} + {( \frac{\partial Φ}{\partial μ} )}^{T} or , \\ & ( 34 ) \\ {∇}_{μ} Φ := {( \frac{ⅆ Φ}{ⅆ μ} )}^{T} = ( {\sum }_{z} {( \frac{\partial Φ}{\partial {Ψ}^{z}} )}^{T} \frac{\partial {Ψ}^{z}}{\partial μ} ) + {( \frac{\partial Φ}{\partial μ} )}^{T} , & ( 35 )\end{matrix}$$

which contains three distinct terms. The last term

$${( \frac{\partial Φ}{\partial μ} )}^{T}$$

is zero, because Φ is not an explicit function of the internal properties. The middle term

$$\frac{\partial {Ψ}^{z}}{\partial μ}$$

can be calculated from equation 26 of the forward model. The derivatives with respect to μₐ and μₛ are:

$$\begin{matrix}{( \frac{\partial {Ψ}^{2}}{\partial {μ}_{s}} )}_{k , i , j} = ω \frac{{\sum }_{{k}^{′} = 1}^{K} {a}_{{k}^{′}} {p}_{k , k} {Ψ}_{k , i , j}^{z - 1}}{\{ \frac{{ξ}_{K}}{Δ x} + \frac{{η}_{k}}{Δ y} + ( {μ}_{a} + {μ}_{s} ) \}} - ω \frac{\{ {S}_{k , i , j} + {μ}_{s} {\sum }_{{k}^{′} = 1}^{K} {a}_{{k}^{′}} {p}_{k , {k}^{′}} {Ψ}_{k , i , j}^{z - 1} + \frac{{ξ}_{k}}{Δ x} {Ψ}_{k , i - 1 , j}^{z} + \frac{{η}_{k}}{Δ y} {Ψ}_{k , i , j - 1}^{z} \}}{\{ \frac{{ξ}_{K}}{Δ x} + \frac{{η}_{k}}{Δ y} + ( {μ}_{a} + {μ}_{s} ) \}} \\ & ( 36 a ) \\ {( \frac{\partial {Ψ}^{2}}{\partial {μ}_{a}} )}_{k , i , j} = - ω \frac{\{ {S}_{k , i , j} + {μ}_{s} {\sum }_{{k}^{′} = 1}^{K} {a}_{{k}^{′}} {p}_{k , {k}^{′}} {Ψ}_{k , i , j}^{z - 1} + \frac{{ξ}_{k}}{Δ x} {Ψ}_{k , i - 1 , j}^{z} + \frac{{η}_{k}}{Δ y} {Ψ}_{k , i , j - 1}^{z} \}}{{\{ \frac{{ξ}_{K}}{Δ x} + \frac{{η}_{k}}{Δ y} + ( {μ}_{a} + {μ}_{s} ) \}}^{2}} . & ( 36 b )\end{matrix}$$

At this point the adjoint differentiation technique has not yet been used, since the process has not stepped backward through the forward code. This procedure comes into play in the calculation of the first term

$${( \frac{\partial Φ}{\partial {Ψ}^{z}} )}^{T}$$

in equation 35. This can be best understood while looking at the computational graph of the adjoint differentiation technique in FIG. 3B. Starting with the last step (output) of the forward code, which is the calculation of the objective function given the predictions P=Ψ^{Z}, Φ is differentiated with respect to Ψ^{Z} and multiply it with

$${( \frac{\partial Φ}{\partial Φ} )}^{T} = 1.$$

. The result is difference between the measured and predicted data,

$${( \frac{\partial Φ}{\partial {Ψ}^{Z}} )}^{T} = {( {Ψ}^{Z} - M )}^{T} . \qquad ( 37 )$$

This is the input to our adjoint model, which will eventually provide the gradient Δ_{μ}Φ. More specifically,

$${( \frac{\partial Φ}{\partial {Ψ}^{z - 1}} )}^{T}$$

is calculated by continuing to step backward through the forward code and is given by:

$${( \frac{\partial Φ}{\partial {Ψ}^{z - 1}} )}^{T} = {( \frac{\partial {Ψ}^{z}}{\partial {Ψ}^{z - 1}} )}^{T} {( \frac{\partial Φ}{\partial {Ψ}^{z}} )}^{T} . \qquad ( 38 )$$

The remaining derivatives

$${( \frac{\partial Φ}{\partial {Ψ}^{z}} )}^{T}$$

of all intermediate steps in equation 35 are computed using the previously calculated derivatives

$${( \frac{\partial Φ}{\partial {Ψ}^{z + 1}} )}^{T} ,$$

, such that

$$\begin{matrix}{( \frac{\partial Φ}{\partial {Ψ}^{z}} )}^{T} = \frac{\partial ( Φ• ⃛ {•Ψ}^{z + 1} ) {( {Ψ}^{z} )}^{T}}{\partial {Ψ}^{z}} \\ = {( \frac{\partial {Ψ}^{z + 1}}{\partial {Ψ}^{z}} )}^{T} \cdot \frac{\partial ( Φ• ⃛ {•Ψ}^{z + 2} ) {( {Ψ}^{z + 1} )}^{T}}{\partial {Ψ}^{z + 1}} \\ = {( \frac{\partial {Ψ}^{z + 1}}{\partial {Ψ}^{z}} )}^{T} \cdot {( \frac{\partial Φ}{\partial {Ψ}^{z + 1}} )}^{T} .\end{matrix} \qquad ( 39 )$$

This step, in which

$${( \frac{\partial Φ}{\partial {Ψ}^{z}} )}^{T}$$

is calculated from

$${( \frac{\partial Φ}{\partial {Ψ}^{z + 1}} )}^{T} ,$$

constitutes the adjoint differentiation step in our code. The matrix

$${( \frac{\partial {Ψ}^{z + 1}}{\partial {Ψ}^{z}} )}^{T}$$

is calculated by analytically differentiating the (z+1)-th SOR-iteration step, given in equation 26, with respect to Ψ^{Z}. We get, for example in the case of ordinates with ξₖ>0, ηₖ>0:

$$\frac{\partial {Ψ}_{k , 1 , J}^{z + 1}}{\partial {Ψ}_{{k}^{′} , {i}^{′} , {j}^{′}}^{z}} = ( 1 - ω ) {δ}_{k , i , j} + ω \frac{\{ {μ}_{s} {a}_{{k}^{′}} {p}_{k , {k}^{′}} {δ}_{i , j} + \frac{{ξ}_{k}}{Δ x} {δ}_{k , i - 1 , j} + \frac{{η}_{k}}{Δ y} {δ}_{k , i , j - 1} \}}{\{ \frac{{ξ}_{k}}{Δ x} + \frac{{η}_{k}}{Δ y} + ( {μ}_{a} + {μ}_{s} ) \}} \\ with {δ}_{a , b , c} = {δ}_{a} {δ}_{b} {δ}_{c} and {δ}_{x} = \{ \begin{matrix}1 & if x = {x}^{′} \\ 0 & if x \neq {x}^{′}\end{matrix} . \\ Here , the approximations \\ \frac{{ξ}_{k}}{Δ x} \frac{\partial {Ψ}_{k , i - 1 , j}^{z + 1}}{\partial {Ψ}_{k , i , j}^{z}} ≅ \frac{{ξ}_{k}}{Δ x} {δ}_{k , i - 1 , j} and \frac{{ξ}_{k}}{Δ y} \frac{\partial {Ψ}_{k , i , j - 1}^{z + 1}}{\partial {Ψ}_{k , i , j}^{z}} ≅ \frac{{ξ}_{k}}{Δ y} {δ}_{k , i - 1 , j} \qquad ( 40 )$$

Here, the approximations can be made for the relevant terms on the right hand side of equation 40.

As can be seen, the gradient of the objective function is calculated by stepping backward through all previously calculated iteration steps of the forward model without solving an entirely new numerical adjoint equation of radiative transfer. Furthermore, the particular underlying physical system does not have to be known, because the derivative is computed directly from the elementary steps of the forward model code (equations 26 and 28).

3. Gradient-Based Optimization

Once the gradient Δ_{μ}Φ(μ₀) for a point μ₀ is obtained, a one-dimensional line minimization along the given gradient direction is performed until a minimum, Φ(μₘᵢₙ) is found, FIG. 1, step 135 (inner iteration). Various techniques can be applied to perform such one-dimensional minimizations. Exemplary techniques are disclosed in Nash S G, Sofer A. Linear and nonlinear programming, McGraw-Hill, New York, 1996, and Press W H, Teukolsky S A, Vetterling W T, and Flannery B P. Numerical Recipes in C. Cambridge University Press, New York, (1992). One approach is to start with three points, the initial guess μ₀, μ₁=μ₀+Δμ, and μ₂=μμ₀+2Δμ chosen along the direction of the gradient. After calculating the objective function at these three points, the largest calculated value is neglected, and a new guess μ₃ is determined using the golden section rule until a minimum is bracketed. At that time a parabola is fit through these three points. The smallest value of the objective function on this parabola is determined to be the minimum. Once the point (guess) μ_{min,1} is found for which Φ(μ_{min,1}) is minimal along the one-dimensional subspace, a new gradient calculation Δ_{μ}Φ(μ_{min,1}) is performed at the minimum μ_{min,1} and a new direction is chosen in a conjugate-gradient framework. For this a Polak-Riberie conjugate-gradient scheme can be employed (outer iterations.)

After completing several inner and outer iterations a final point μ_{min,final} is found for which Φ(μ_{min,final}) is smaller than for all other points μₘᵢₙ before. The final reconstruction image is than given by μ_{min,final}, wherein μ_{min,final} represents the spatial distribution of the optical properties in the target medium. The image can be represented by any known means, such as on a computer monitor or printed as a hard copy on paper, wherein the property values of the medium may be represented as shades of gray or colors.

Although illustrative embodiments have been described herein in detail, those skilled in the art will appreciate that variations may be made without departing from the spirit and scope of this invention. Moreover, unless otherwise specifically stated, the terms and expressions used herein are terms of description and not terms of limitation, and are not intended to exclude any equivalents of the system and methods set forth in the following claims.

What is claimed is:

1. A method for reconstructing an image of a scattering medium, comprising:
directing energy into the scattering medium at a source location on the scattering medium;
measuring the energy emerging from the scattering medium at a detector location on the scattering medium;
selecting an initial guess of internal properties of the scattering medium;
predicting the energy emerging from the scattering medium using an equation of radiative transfer, wherein the prediction is a function of the initial guess;
generating an objective function based on a comparison of the prediction with the measurement;
generating a gradient of the objective function by a method of adjoint differentiation;
modifying the initial guess of the properties of the scattering medium based on the gradient of the objective function; and
generating an image representation of the internal properties of the scattering medium.

2. The method according to claim 1, further comprising repeating the predicting of the energy emerging from the scattering medium based on the modified initial guess, generating the objective function and modifying the initial guess, until at least one of a predetermined number of repetitions has occurred and the objective function reaches a predetermined threshold.

3. The method according to claim 1, wherein the prediction depends on the boundary conditions.

4. The method according to claim 3, wherein the boundary conditions account for a refractive mismatch at an interface between the medium and at least one of the detectors and source.

5. The method according to claim 1, wherein the prediction comprises an iterative process producing intermediate results.

6. The method according to claim 5, wherein the intermediate results of the prediction are stored.

7. The method according to claim 6, wherein generating the gradient of the objective function by adjoint differences uses the intermediate results of the prediction.

8. The method according to claim 7, wherein generating the gradient comprises stepping backward through the intermediate results of the prediction.

9. The method according to claim 1, wherein the equation of radiative transfer is time independent.

10. The method according to claim 9, wherein the time independent equation of radiative transfer is:
ωΔΨ(r,ω)+(μₐ+μₛ)Ψ(r,ω)=S(r,ω)+μₛ∫₀^{2π}ρ(ω, ω′)Ψ(r,ω′)dω′
where Ψ(r,ω)is the radiance at the spatial position r directed into a unit solid angle ω, S(r,w) is the energy directed into the medium at spatial position r into a unit solid angle ω, μₛ is the scattering coefficient, μ_{α} is the absorption coefficient and ρ(ω, ω′) is the scattering phase function.

11. The method according to claim 10, wherein the scattering phase function is:
$$p ( cos θ ) = \frac{1 - {g}^{2}}{2 {( 1 + {g}^{2} - 2 g cos θ )}^{3 / 2}}$$
where θ is the angle between the two unit solid angles ω and ω′, and g is the anisotropy factor.

12. The method according to claim 1, wherein the equation of radiative transfer is time dependent.

13. The method according to claim 12, wherein the time dependent equation of radiative transfer is:
$$\frac{1}{c} \frac{\partial Ψ ( r , ω , t )}{\partial t} = S ( r , ω , t ) - ω \cdot ∇ Ψ ( r , ω , t ) - ( {μ}_{a} + {μ}_{s} ) Ψ ( r , ω , t ) + {μ}_{s} {\int }_{0}^{2 π} p ( ω , {ω}^{′} ) Ψ ( r , {ω}^{′} , t ) ⅆ {ω}^{′}$$
where Ψ(r,ω, t) is the radiance at the spatial position r directed into a unit solid angle ω, S(r,w, t) is the energy directed into the medium at spatial position r into a unit solid angle ω, μₛ is the scattering coefficient, μₐ is the absorption coefficient and ρ(ω, ω′) is the scattering phase function.

14. The method according to claim 13, wherein the scattering phase function is:
$$p ( cos θ ) = \frac{1 - {g}^{2}}{2 {( 1 + {g}^{2} - 2 g cos θ )}^{3 / 2}}$$
where θ is the angle between the two unit solid angles ω and ω′, and g is the anisotropy factor.

15. The method according to claim 1, wherein the properties include at least one of a scattering coefficient, an absorption coefficient, an anisotropy factor, and a scattering phase function.

16. The method according to claim 1, wherein the objective function is a normalized comparison of the predicted energy and the measured energy.

17. The method according to claim 1, wherein the objective function is based on the normalized sum of the differences between the predicted energy and the measured energy for each source detector pair, wherein a source detector pair is formed between each source location and each detector location.

18. The method according to claim 1, wherein the objective function is:
$$ϕ = \frac{1}{2} {{\sum }_{i}}^{m} {( {P}_{i} - {M}_{i} )}^{2}$$
where Mᵢ represents the actual measurements and the Pᵢ represents the predicted measurements for each source defector pair i, m is the number of source detector pairs, where a source detector pairs is formed between each source location and each detector location.

19. The method according to claim 1, further comprising minimizing the objective function.

20. The method according to claim 19, wherein minimizing the objective function includes a one dimensional line search.

21. The method according to claim 20, wherein the one dimensional line search is performed along a direction of the gradient of the objective function.

22. The method according to claim 20, wherein the one dimensional line search is performed along a gradient-dependent direction.

23. The method according to claim 1, wherein the energy comprises near infra-red energy.

24. The method according to claim 1, wherein the scattering medium contains regions wherein the scattering coefficients are not substantially greater than the absorption coefficients.

25. The method according to claim 1, wherein the scattering medium contains a low scattering region embedded in a high scattering region.

26. The method according to claim 1, wherein the predicted energy is determined using finite element methods.

27. The method according to claim 1, wherein the predicted energy is determined using finite difference methods.

28. A method for imaging the spatial optical properties of tissue, comprising:
(a) directing energy into the scattering medium at a source location on the tissue;
(b) measuring the energy emerging from the scattering medium at a detector location on the tissue;
(c) selecting and initial guess of the spatial optical properties of the tissue;
(d) predicting the energy emerging from the tissue using an equation of radiative transfer in an iterative process, wherein the prediction is a function of the initial guess and a refraction index mismatch at a boundary of the tissue, and the iterative process generates a plurality of intermediate predictions;
(e) generating an objective function based on a normalized comparison of the prediction with the measured energy emerging from the scattering medium;
(f) generating a gradient of the objective function by adjoint differentiation;
(g) modifying the initial guess of the spatial properties of the tissue based on the gradient of the objective function;
(h) repeating steps (d) through (g) until at least one of a threshold of modifications to the initial guess is reached and the objective function reaches a threshold; and
(i) generating an image representation of the spatial optical properties of the tissue.

29. A system for reconstructing an image of a scattering medium, comprising:
a source for directing energy into the scattering medium at source location on the scattering medium;
a detector for measuring the energy emerging from the scattering medium at a detector location on the scattering medium;
an initial guess of internal properties of the scattering medium;
means for predicting the energy emerging from the scattering medium using an equation of radiative transfer, wherein the prediction is a function of the initial guess;
means for generating an objective function based on a comparison of the prediction with the measurement;
means for generating a gradient of the objective function by a method of adjoint differentiation;
means for modifying the initial guess of the properties of the scattering medium based on the gradient of the objective function; and
means for generating an image representation of the internal properties of the scattering medium.

30. The system according to claim 1, farther comprising means for repeating the predicting of the energy emerging from the scattering medium based on the modified initial guess, generating the objective function and modifying the initial guess, until at least one of a predetermined number of repetitions has occurred and the objective function reaches a predetermined threshold.

31. The system according to claim 1, wherein the prediction depends on the boundary conditions.

32. The system according to claim 31, wherein the boundary conditions account for a refractive mismatch at an interface between the medium and at least one of the detectors and source.

33. The system according to claim 1, wherein the prediction comprises an iterative process producing intermediate results.

34. The system according to claim 33, wherein the intermediate results of the prediction are stored.

35. The system according to claim 34, wherein generating the gradient of the objective function by adjoint differences uses the intermediate results of the prediction.

36. The system according to claim 35, wherein generating the gradient comprises stepping backward through the intermediate results of the prediction.

37. The system according to claim 1, wherein the equation of radiative transfer is time independent.

38. The system according to claim 37, wherein the time independent equation of radiative transfer is:
ωΔΨ(r,ω)+(μₐ+μₛ)Ψ(r,ω)=S(r,ω)+μₛ∫₀^{2π}ρ(ω, ω′)Ψ(r,ω′)dω′
where Ψ(r,ω) is the radiance at the spatial position r directed into a unit solid angle ω, S(r,w) is the energy directed into the medium at spatial position r into a unit solid angle ω, μₛ is the scattering coefficient, μₐ is the absorption coefficient and ρ(ω,ω′) is the scattering phase function.

39. The system according to claim 38, wherein the scattering phase function is:
$$p ( cos θ ) = \frac{1 - {g}^{2}}{2 {( 1 + {g}^{2} - 2 g cos θ )}^{3 / 2}}$$
where θ is the angle between the two unit solid angles ω and ω′, and g is the anisotropy factor.

40. The system according to claim 1, wherein the equation of radiative transfer is time dependent.

41. The system according to claim 40, wherein the time dependent equation of radiative transfer is:
$$\frac{1}{c} \frac{\partial Ψ ( r , ω , t )}{\partial t} = S ( r , ω , t ) - ω \cdot ∇ Ψ ( r , ω , t ) - ( {μ}_{a} + {μ}_{s} ) Ψ ( r , ω , t ) + {μ}_{s} {\int }_{0}^{2 π} p ( ω , {ω}^{′} ) Ψ ( r , {ω}^{′} , t ) ⅆ {ω}^{′}$$
where Ψ(r,ω, t) is the radiance at the spatial position r directed into a unit solid angle ω, S(r,w,t) is the energy directed into the medium at spatial position r into a unit solid angle ω, μₛ is the scattering coefficient, μₐ is the absorption coefficient and ρ(ω,ω′) is the scattering phase function.

42. The system according to claim 41, wherein the scattering phase function is:
$$p ( cos θ ) = \frac{1 - {g}^{2}}{2 {( 1 + {g}^{2} - 2 g cos θ )}^{3 / 2}}$$
where θ is the angle between the two unit solid angles ω and ω′, and g is the anisotropy factor.

43. The system according to claim 1, wherein the properties include at least one of a scattering coefficient, an absorption coefficient, an anisotropy factor, and a scattering phase function.

44. The system according to claim 1, wherein the objective function is a normalized comparison of the predicted energy and the measured energy.

45. The system according to claim 1, wherein the objective function is based on the normalized sum of the differences between the predicted energy and the measured energy for each source detector pair, wherein a source detector pair is formed between each source location and each detector location.

46. The system according to claim 1, wherein the objective function is:
$$ϕ = \frac{1}{2} {\sum }_{i}^{m} {( {P}_{i} - {M}_{i} )}^{2}$$
where Mᵢ represents the actual measurements and Pᵢ represents the predicted measurements for each source detector pair, m is the number of source detector pairs, where a source detector pairs is formed between each source location and each detector location.

47. The system according to claim 1, further comprising minimizing the objective function.

48. The system according to claim 47, wherein minimizing the objective function includes a one dimensional line search.

49. The system according to claim 48, wherein the one dimensional line search is performed along a direction of the gradient of the objective function.

50. The system according to claim 49, wherein the one dimensional line search is performed along a gradient-dependent direction.

51. The system according to claim 50, wherein the energy comprises near infra-red energy.

52. The system according to claim 1, wherein the scattering medium contains regions wherein the scattering coefficients are not substantially greater than the absorption coefficients.

53. The system according to claim 1, wherein the scattering medium contains a low scattering region embedded in a high scattering region.

54. The system according to claim 1, wherein the predicted energy is determined using finite element methods.

55. The system according to claim 1, wherein the predicted energy is determined using finite difference methods.

56. A system for imaging the spatial distribution of optical properties of tissue, comprising:
(a) a source for directing energy into the scattering medium at a source location on the tissue;
(b) a detector for measuring the energy emerging from the scattering medium at a detector location on the tissue;
(c) an initial guess of spatial optical properties of the tissue;
(d) means for predicting the energy emerging from the tissue using an equation of radiative transfer in an iterative process, wherein the prediction is a function of the initial guess and a refraction index mismatch at a boundary of the tissue, and the iterative process generates a plurality of intermediate predictions;
(e) means for generating an objective function based on a normalized comparison of the prediction with the measured energy emerging from the scattering medium;
(f) means for generating a gradient of the objective function by adjoint differentiation;
(g) means for modifying the initial guess of the spatial properties of the tissue based on the gradient of the objective function;
(h) means for repeating steps (d) through (g) until at least one of a threshold of modifications to the initial guess is reached and the objective function reaches a threshold; and
(i) means for generating an image representation of the spatial optical properties of the tissue.

57. Computer executable software code stored on a computer readable medium, the code for reconstructing an image of a scattering medium, comprising:
code to direct energy into the scattering medium at a source location on the scattering medium;
code to measure the energy emerging from the scattering medium at a detector location on the scattering medium;
code to receive an initial guess of internal properties of the scattering medium;
code to predict the energy emerging from the scattering medium using an equation of radiative transfer, wherein the prediction is a function of the initial guess;
code to generate an objective function based on a comparison of the prediction with the measurement;
code to generate a gradient of the objective function by a method of adjoint differentiation;
code to modify the initial guess of the properties of the scattering medium based on the gradient of the objective function; and
code to generate an image representation of the internal properties of the scattering medium.

58. Computer executable software code stored on a computer readable medium, the code for imaging the spatial distribution of optical properties of tissue, comprising:
(a) code to direct energy into the scattering medium at a source location on the tissue;
(b) code to measure the energy emerging from the scattering medium at a detector location on the tissue;
(c) code to receive an initial guess of spatial optical properties of the tissue;
(d) code to predict the energy emerging from the tissue using an equation of radiative transfer in an iterative process, wherein the prediction is a function of the initial guess and a refraction index mismatch at a boundary of the tissue, and the iterative process generates a plurality of intermediate predictions;
(e) code to generate an objective function based on a normalized comparison of the prediction with the measured energy emerging from the scattering medium;
(f) code to generate a gradient of the objective function by adjoint differentiation;
(g) code to modify the initial guess of the spatial properties of the tissue based on the gradient of the objective function;
(h) code to repeat steps (d) through (g) until at least one of a threshold of modifications to the initial guess is reached and the objective function reaches a threshold; and
(i) code to generate an image representation of the spatial optical properties of the tissue.

59. A computer readable medium having computer executable software code stored thereon, the code for reconstructing an image of a scattering medium, comprising:
code to direct energy into the scattering medium at a source location on the scattering medium;
code to measure the energy emerging from the scattering medium at a detector location on the scattering medium;
code to receive an initial guess of internal properties of the scattering medium;
code to predict the energy emerging from the scattering medium using an equation of radiative transfer, wherein the prediction is a function of the initial guess;
code to generate an objective function based on a comparison of the prediction with the measurement;
code to generate a gradient of the objective function by a method of adjoint differentiation;
code to modify the initial guess of the properties of the scattering medium based on the gradient of the objective function; and
code to generate an image representation of the internal properties of the scattering medium.

60. A computer readable medium having computer executable software code stored thereon, the code for imaging the spatial distribution of optical properties of tissue, comprising:
(a) code to direct energy into the scattering medium at a source location on the tissue;
(b) code to measure the energy emerging from the scattering medium at a detector location on the tissue;
(c) code to receive an initial guess of spatial optical properties of the tissue;
(d) code to predict the energy emerging from the tissue using an equation of radiative transfer in an iterative process, wherein the prediction is a function of the initial guess and a refraction index mismatch at a boundary of the tissue, and the iterative process generates a plurality of intermediate predictions;
(e) code to generate an objective function based on a normalized comparison of the prediction with the measured energy emerging from the scattering medium;
(f) code to generate a gradient of the objective function by adjoint differentiation;
(g) code to modify the initial guess of the spatial properties of the tissue based on the gradient of the objective function;
(h) code to repeat steps (d) through (g) until at least one of a threshold of modifications to the initial guess is reached and the objective function reaches a threshold; and
(j) code to generate an image representation of the spatial optical properties of the tissue.
